(19) United States
(12) Patent Application Publication
(10) Pub. No.: US 2016/0165328 A1
(43) Pub. Date: Jun. 9, 2016

(54) RECHARGEABLE RADIO

(71) Applicant: MAKITA CORPORATION, Anjo-shi, Aichi (JP)

(72) Inventors: Tomoyuki OTA, Anjo-shi (JP); Kazunori TSUGE, Anjo-shi (JP); Kentaro KOURA, Anjo-shi (JP); Tomohiro UKAI, Anjo-shi (JP); Yasushi OGURA, Anjo-shi (JP); Taosuke UKAI, Anjo-shi (JP)

(73) Assignee: MAKITA CORPORATION, Anjo-shi, Aichi (JP)

(21) Appl. No.: 14/907,674

(22) PCT Filed: Mar. 26, 2014
(86) PCT No.: PCT/JP2014/058467

§ 371 Date: Jan. 26, 2016

(30) Foreign Application Priority Data
Jul. 23, 2013 (JP) 2013-152744

(51) Int. Cl. H04R 1/02; H04R 3/00

(52) U.S. Cl. CPC H04R 1/02; H04R 3/00

(57) ABSTRACT

A rechargeable radio is provided with battery attachment portion for attaching electric power tool battery and radio communication section. An input section, of which an operation input is performed in rechargeable radio, is connected to control section. Input section includes an operation part and microphone part. Output section, of which a sound output and a display output are performed in rechargeable radio, is connected to control section. Audio output section outputs sound based on sound output signal transmitted from control section. Rechargeable radio is configured to access to radio communication function of smart phone via radio communication section, whereby it is possible to perform sound input and output relating to smart phone through rechargeable radio. As a result, added values of rechargeable radio are improved, thereby achieving improvement in terms of interests of rechargeable radio including convenience.

### TECHNICAL FIELD

The present invention relates to a rechargeable radio to which a battery for an electric power tool is attached as a power source.

### BACKGROUND ART

For example, a rechargeable radio as disclosed in Japanese Patent Application Laid-Open No. 2013-70504 is well known. To such a rechargeable radio, a battery for an electric power tool is attached as a power source. When a radio is thus constructed, it is possible to enjoy listening to the radio by using generous-purpose batteries for the electric power tool.

### SUMMARY OF INVENTION

Nowadays, portable electric devices such as a mobile phone and a portable music player have come into widespread use. In view of this, it is desirable for the rechargeable radio as mentioned above to improve flexibility in terms of linkage with external devices such as portable electric devices. The rechargeable radio thus improved in linkage with external devices can be formed as a highly value-added radio.

The present invention has been made in view of the above circumstances. It is an object of the present invention to improve added values of a rechargeable radio to which an electric power tool battery is attached as a power source by further improving flexibility in terms of linkage with external devices, thereby achieving improvement in terms of interests of a rechargeable radio including convenience.

To achieve the above object, a rechargeable radio according to the present invention adopts the following means. According to a first aspect of the present invention, a rechargeable radio to which an electric power tool battery is attached as a power source comprises a radio communication section configured to perform a radio communication with an external device separate from the rechargeable radio. In the rechargeable radio according to the first aspect, the radio communication section is configured to perform radio communication with the external device separate from the rechargeable radio, and accordingly it is possible to provide the rechargeable radio that is improved in terms of linkage with the external device. Because of this, it is possible to improve added values of the rechargeable radio, and to improve the rechargeable radio in terms of interests including convenience as the rechargeable radio.

According to a second aspect of the present invention, in the rechargeable radio according to the first aspect, an input and output of a sound relating to the external device is performed via the rechargeable radio by performing a radio communication with the external device via the radio communication section. In the rechargeable radio according to the second aspect, a radio communication is performed with the external device via the radio communication section, whereby it is possible to perform an input and output of the sound relating to the external device via the rechargeable radio, so that it is possible to perform the input and output of the sound relating to the external device in a hands-free manner. Because of this, it is possible to perform the input and output of the sound relating to the external device in a hands-free manner even while conducting some works, which is convenient for the user of the rechargeable radio. Examples of the external device include a telephone such as a smart phone allowing a telephone conversation.

According to a third aspect of the invention, in the rechargeable radio according to the first or second aspect, the external device includes an operation input device for performing an operation input relating to the rechargeable radio via the radio communication section. In the rechargeable radio according to the third aspect, using the operation input device as the external device makes it possible to perform an operation input relating to the rechargeable radio via the radio communication section. Because of this, even if a user is away from the rechargeable radio, it is possible to operate the rechargeable radio, which is convenient for the user of the rechargeable radio.

According to a fourth aspect of the invention, in the rechargeable radio according to the third aspect, a function for performing the operation input is installed in the external device having other functions by installing an application provided from outside. It means that, the other functions of the external device, for example, include a function of a mobile phone, a function of an electronic notebook, a function of a calculator, and a function of a personal computer, which are not the functions of the external device dedicated to the operation input. In the rechargeable radio according to the fourth aspect, the function of the operation input device is installed in the external device having another functions, so that it is possible to easily utilize the external device having another functions as the operation input device. Because of this, it is possible to perform an operation input to the rechargeable radio by the external device which the user possesses for some other purposes, which is convenient for the user of the rechargeable radio.

According to a fifth aspect of the present invention, in the rechargeable radio according to one of the first to fourth aspects, the radio communication section is configured to transfer a sound data to the external device. In this aspect of the invention, the sound data includes only data on simple sound but also appropriate data information comprising a sound file (information about data creation time, information about owners of the data, and information relating to other data). In the rechargeable radio according to the fifth aspect, sound data of the rechargeable radio is transferred to an external device. Because of this, it is possible for the user of the rechargeable radio to enjoy a radio broadcasting, music, etc. through the rechargeable radio by using the external device.

According to a sixth aspect of the invention, in the rechargeable radio according to the fifth aspect, the rechargeable radio includes a data storage part that stores the sound data, and the external device includes an other rechargeable radio separate from the rechargeable radio. Furthermore, the sound data stored in the data storage part in the rechargeable radio can be utilized in the other rechargeable radio via the radio communication section. In the rechargeable radio according to the sixth aspect, the sound data to be enjoyed through one rechargeable radio can be utilized by the other rechargeable radio. Because of this, a radio broadcasting, music, etc. that can be enjoyed through one rechargeable radio can be enjoyed through a plurality of rechargeable radios, which is convenient for the user of the rechargeable radio.

According to a seventh aspect of the invention, in the rechargeable radio according to one of the first to sixth aspects, a radio communication is performed between the radio communication section of the rechargeable radio and that of the other rechargeable radio. In the rechargeable radio according to the seventh aspect, the sound data input to one rechargeable radio via the radio communication section can be output and utilized in the other rechargeable radios. Because of this, the output of one rechargeable radio can be output through a plurality of rechargeable radios, making it possible to expand a range where the sound is audible.

According to an eighth aspect of the invention, in the rechargeable radio according to one of the first to seventh aspects, a sound input through a microphone part of the rechargeable radio is output from a speaker part of the other rechargeable radio via the radio communication section. In the rechargeable radio according to the eighth aspect, the sound input through the microphone part of one rechargeable radio is output from the speaker part of the other rechargeable radios via the radio communication section, so that it is possible for the user of the plurality of rechargeable radios to utilize these rechargeable radios like loudspeakers, which is convenient for the user of the rechargeable radio.

According to a ninth aspect of the invention, in the rechargeable radio according to one of the first to eighth aspects, the rechargeable radio includes a control processing part configured to control and process an output to the speaker part in correspondence with an input from the microphone part. Furthermore, the control processing part generates a sound whose frequency includes a reverse phase with respect to the sound input from the microphone part, and outputs the generated sound to the speaker part. In the rechargeable radio according to the ninth aspect, it is possible to decrease the volume of external sound by the sound output from the rechargeable radio. Because of this, it is possible to decrease a volume of the noisy sound on a work site, making it possible to make it easier to understand conversation voices on the work site, and to decrease a noise level with respect to the environment, thus making it possible to improve a work environment.

This function by which the volume of an external sound is thus decreased may also be used like that of a noise canceller for canceling noises. When this function is thus used, the sound output from the rechargeable radio (radio broadcasting, music, conversation voices, etc.) can be made easier to understand.

According to a tenth aspect of the invention, in the rechargeable radio according to one of the first to ninth aspects, the rechargeable radio includes a battery remaining capacity detection part configured to detect a remaining capacity of the electric power tool battery attached as the power source. Furthermore, when the remaining capacity detected by the battery remaining capacity detection part becomes less than a predetermined value, a signal relating to the remaining capacity is transmitted to the external device via the radio communication section. In the rechargeable radio according to the tenth aspect, it is possible for the user of the rechargeable radio user to recognize through the external device that the remaining capacity of the electric power tool battery attached as the power source has been decreased. Because of this, it is possible for the user of the rechargeable radio user to easily recognize when to replace the electric power tool battery used for the power source of the rechargeable radio.

In a case where the user of the rechargeable radio carries a portable external device as the external device, it is possible for the user of the rechargeable radio to recognize when to replace the electric power tool battery earlier and more easily.

According to an eleventh aspect of the invention, in the rechargeable radio according to one of the first to tenth aspects, when the radio communication with the external device via the radio communication section is disconnected, information about the disconnection is informed. In the rechargeable radio according to the eleventh aspect, it is possible for the user of the rechargeable radio user to recognize that a distance between the external device and the rechargeable radio has become not less than a predetermined distance through information from the control processing part regarding the disconnection of the radio communication with the radio communication section. Because of this, when, for example, the rechargeable radio is likely to be stolen, it is possible for the user of the rechargeable radio user to recognize that the rechargeable radio is being taken away.

### BRIEF DESCRIPTION OF THE DRAWINGS

FIG. 1 is a block diagram schematically showing the system configuration of a rechargeable radio.

FIG. 2 is a first usage example schematically showing how the rechargeable radio is used.

FIG. 3 is a second usage example schematically showing how the rechargeable radio is used.

FIG. 4 is a third usage example schematically showing how the rechargeable radio is used.

FIG. 5 is a fourth usage example schematically showing how the rechargeable radio is used.

FIG. 6 is a fifth usage example schematically showing how the rechargeable radio is used.

### EMBODIMENTS FOR CARRYING OUT THE INVENTION

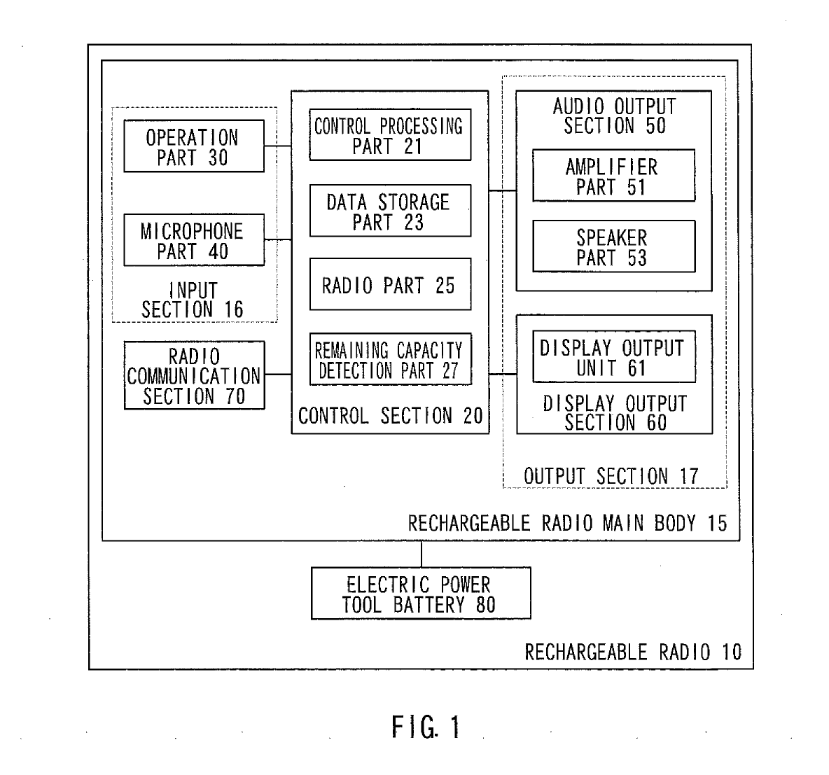

In the following, an embodiment of a rechargeable radio according to the present invention will be described. FIG. 1 is a block diagram schematically showing the system configuration of a rechargeable radio 10 according to the embodiment. This rechargeable radio 10 may be a rechargeable radio to which an electric power tool battery 80 is attached as a power source. The rechargeable radio 10 may be provided with a battery attachment portion for attaching the electric power tool battery 80. This battery attachment portion may be provided so as to allow slide attachment of the electric power tool battery 80. The electric power tool battery 80 may be detachable as the power source of a rechargeable electric power tool.

This electric power tool battery 80 may be slidably attached and detached to and from the tool main body of the electric power tool. The electric power tool battery 80 attached to the tool main body may be used as the power source of the electric power tool. The electric power tool battery 80 used as the power source may consume a charged power, and when an amount of the charged power becomes less than a predetermined value, the electric power tool battery 80 may be detached from the tool main body and can be recharged by a charger. The recharged electric power tool battery 80 may be attached to the tool main body again as the power source of the electric power tool, and may be used as the power source of the electric power tool. That is, the electric power tool battery 80 may be an electric power tool battery which rotates a drive motor by applying recharged power to the electric power tool.

Examples of the electric power tool may include an electrically driven electric power tool such as a driver, a wrench, a drill, a reciprocating saw, a chain saw, a band saw, a jig saw, a circular saw, a grinder, or a tacker. Examples of the electric power tool battery 80 may include a product of “BL1430” in the Makita general catalog issued on April 2012. Similar to the tool main body, the rechargeable radio 10 which uses the electric power tool battery 80 as the power source may be provided with a battery attachment portion which may allow slide attachment and detachment. That is, the battery attachment portion of the rechargeable radio 10 may also employ a slide attachment system in which slide attachment and detachment can be performed.

As shown in FIG. 1, the rechargeable radio 10 may be configured such that the electric power tool battery 80 used for the power source may be attached to a rechargeable radio main body 15. As shown in the block diagram of FIG. 1, in the rechargeable radio main body 15, an input section 16, an output section 17, and a radio communication section 70 may be connected to a control section 20.

The control section 20 may generally include a control processing part 21, a data storage part 23, a radio part 25, and a remaining capacity detection part 27. The control processing part 21 may be formed as a microcomputer configured to perform various control processing operations in the rechargeable radio 10. More specifically, similar to an general-purpose microcomputer, the control processing part 21 may include a CPU (central processing unit), a ROM (read only memory), and a RAM (random access memory). The data storage part 23 may be formed as a storage device that can store large-sized data files such as music and/or images. More specifically, the data storage part 23 may include, for example, a flash memory (non-volatile semiconductor memory) or a hard disk (magnetic disk). The data storage part 23 can store (memorize) a large-sided data file such as music and/or images.

The radio part 25 may be formed by radio components allowing the rechargeable radio 10 to function as a radio. The radio components may be widely used, and accordingly a detailed description thereof will be omitted. The remaining capacity detection part 27 may be configured to detect a remaining amount of a charged electric power tool battery 80 attached to the battery attachment portion. As shown in FIG. 1, the remaining capacity detection part 27 may be included in a part of the control section 20 described above. The remaining capacity detection part 27 may be designed such that when a detection signal transmitted from the electric power tool battery 80 attached to the battery attachment portion is judged to be within a predetermined range, it may be judged that the remaining amount of the charged electric power tool battery 80 is small and a control processing needs to be performed, which is described below.

The input section 16, to which an operation for the rechargeable radio 10 is input, may be connected to the control section 20. The input section 16 may generally include an operation part 30 and a microphone part 40. The operation part 30 may include an input switch and an input dial etc. through which an appropriate operation is input for the rechargeable radio 10. More specifically, the operation part 30 may include a main switch for turning on/off the main power source of the rechargeable radio 10, a changeover switch for switching a frequency band between AM broadcasting and FM broadcasting, a frequency selection dial for selecting a frequency, a volume adjustment dial for adjusting a volume, and a preset switch configured to perform an instantaneous access and set to a preset frequency, etc. The operation part 30 in which an operation input is performed may transmit an operation signal to the control section 20 in accordance with the operation input. The microphone part 40 may include a microphone unit for inputting a sound from outside the rechargeable radio 10.

The microphone unit may include an appropriate microphone such as a widely used capacitor type microphone or a moving-coil type microphone. An operation input and/or a sound input may be performed to the control section 20 from the input section 16 including the operation part 30 and the microphone part 40. The microphone part 40 in which a sound input is performed may transmit a sound signal to the control section 20 mentioned above in accordance with the sound input. The control processing part 21 may be configured to control and process an output to a speaker part 53 in correspondence with the input from the microphone part 40. For example, the control processing part 21 may be configured to generate a sound whose frequency includes a reverse phase with respect to the sound input from the microphone part 40, and can output the generated sound to the speaker part 53.

The output section 17, by means of which a sound output and/or a display output can be performed from the rechargeable radio 10, may be connected to the control section 20. The output section 17 may generally include an audio output section 50 and a display output section 60. The audio output section 50 may perform a sound output based on a sound output signal transmitted from the control section 20. More specifically, the audio output section 50 may include an amplifier part 51 and a speaker part 53.

The amplifier part 51 may amplify the sound output signal transmitted from the control section 20. The speaker part 53 may perform a sound output, oscillating the signal amplified by the amplifier part 51. The display output section 60 may include a display output unit 61 which allows an external display output. The display output unit 61 may be formed, for example, by a liquid crystal display or a 7-segment display, etc. Through the display output unit 61, a user of the rechargeable radio 10 may recognize a currently selected frequency, an operation number, etc.

A radio communication section 70 may be connected to the above-mentioned control section 20. This radio communication section 70 may perform a radio communication with an external device separate from the rechargeable radio 10. The external device may include any electric device so long as it is an external device provided separately from the rechargeable radio 10. In particular, the external device may include a portable electric devices widely used nowadays such as a smart phone, a tablet, and a portable game machine. The external device may include an electric device related to an input and an output such as a headphone microphone. The external device may include a router allowing a connection to the Internet, and furthermore, it may include a device allowing an access to an external personal computer or a storage device.

It may be noted, however, that, generally speaking, the portable electric devices as mentioned above may mostly include an electronic component of low power consumption allowing a short-distance radio communication. Accordingly, the radio communication section 70 may include an electronic component of low power consumption corresponding to such a short-distance radio communication. For examples, the electronic component of low power consumption corresponding to the short-distance radio communication may include electronic components utilizing the short-distance radio communication standards such as “Bluetooth (registered trademark)” and “ZigBee (registered trademark). Accordingly, the radio communication section 70 may include at least a component utilizing the short-distance radio communication standards.

When the radio communication of this radio communication section 70 is disconnected, the control processing part 21 may perform a processing corresponding to the disconnection of the radio communication. The rechargeable radio 10 thus constructed may improve flexibility in terms of linkage with an external device by the radio communication section 70. As a result, the added value of the rechargeable radio 10 may be improved, and it is possible to achieve improvement in terms of interest of the rechargeable radio including convenience.

The radio communication set 70 may have a construction which requires no connection cord for communicating with the external device and also includes all means allowing bidirectional or one-directional information transmission through a radio communication. That is, the radio communication section 70 may have a construction which includes an electronic component utilizing short-distance radio communication standards such as “Bluetooth (registered trademark)” and “ZigBee (registered trademark)”, and also may have a construction which includes an electronic component utilizing standards for widely used radio LAN (Local Area Network), infrared communication, etc. The radio communication section 70 thus constructed can transfer sound data to the external devices described below.

[First Usage Example]

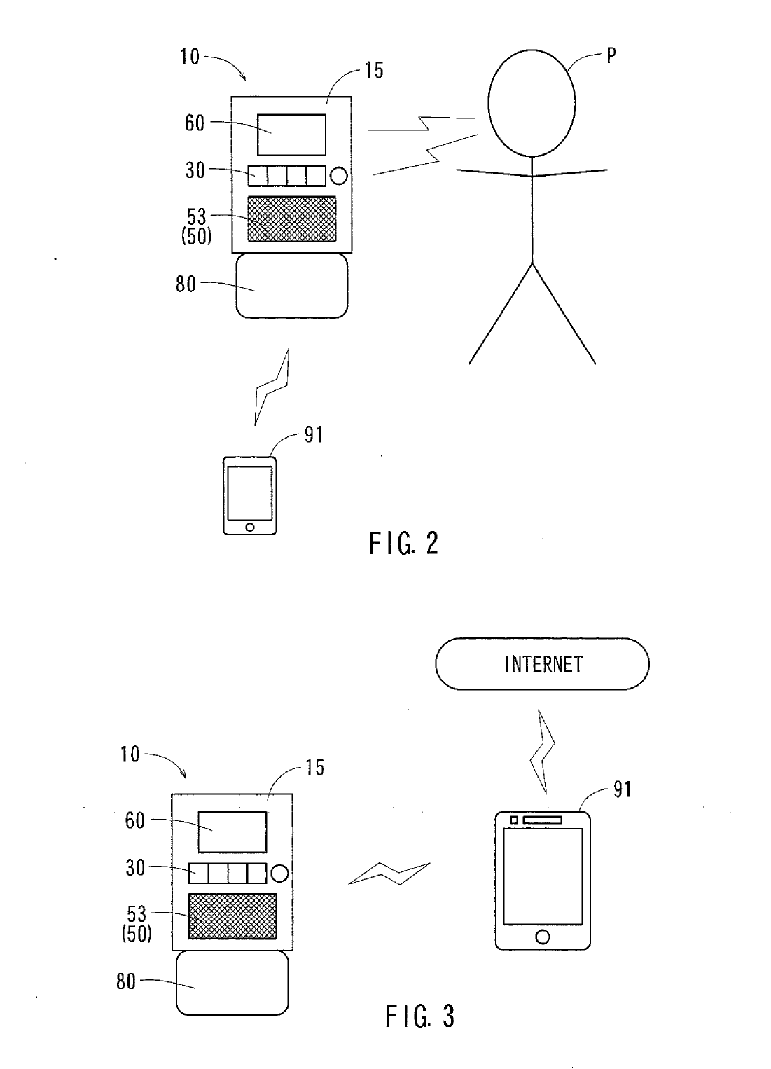

Next, the first usage example of the rechargeable radio 10, constructed as described above, will be described with reference to FIG. 2. FIG. 2 schematically illustrates the first usage example of the rechargeable radio 10. In this first usage example shown in FIG. 2, a smart phone 91 may perform a radio communication with the rechargeable radio 10. The smart phone 91 may correspond to the external device according to the present embodiment. The smart phone 91 may include a radio communication function such as “Bluetooth (registered trademark)” or “ZigBee (registered trademark) allowing an access to the above-mentioned radio communication section 70. The smart phone 91 may have a normal smart phone function, and, i.e. a telephone function, an Internet browsing function, etc. in addition to the above-mentioned radio communication function.

This rechargeable radio 10 may access to the radio communication function of the smart phone 91 via the radio communication section 70, whereby it is possible to perform a sound input and output relating to the smart phone 91 through the rechargeable radio 10. Because of this, a user P of the rechargeable radio may perform a conversation facing the rechargeable radio 10, whereby it is possible to perform a conversation through the smart phone 91 without having to hold the smart phone 91 by hand. That is, the user P of the rechargeable radio 10 may perform a conversation in a hands-free manner through the rechargeable radio 10.

The smart phone 91 performing a radio communication with the rechargeable radio 10 may be placed at a distance from the rechargeable radio 10 allowing a radio communication therewith. Furthermore, the user P of the rechargeable radio 10 may carry the smart phone 91t in a pocket of the user's clothes. The rechargeable radio 10 may be provided with a smart phone accommodation pocket for placing the smart phone 91. In the case where the smart phone 91 is placed on the smart phone accommodation pocket, it is possible to improve reliability in the radio communication with the rechargeable radio 10. The smart phone 91 may also be connected to the rechargeable radio 10 through a cord.

[Second Usage Example]

Next, the second usage example of the rechargeable radio 10, constructed as described above, will be described with reference to FIG. 3. FIG. 3 schematically illustrates the second usage example of the rechargeable radio 10. In the second usage example shown in FIG. 3, the smart phone 91 may correspond to an operation input device as the external device according to the present embodiment. The smart phone 91 may function so as to allow an operation input with respect to the above-mentioned rechargeable radio 10.

The operation input function may include both a function for operating the rechargeable radio 10 and a function for allowing an input and output of the function of the smart phone 91 through the rechargeable radio 10. The smart phone 91 may obtain the operation input function through an installation of an application provided in the Internet. That is, through the functioning of the installed application, the smart phone 91 may perform an operation input with respect to the control section 20 of the rechargeable radio 10.

In the rechargeable radio 10, even when the user is away from the rechargeable radio 10, it is possible for the user to perform an operation input with respect to the rechargeable radio 10 by the smart phone 91 via the radio communication section 70, which is convenient for the user of the rechargeable radio 10. The smart phone 91 having the function of a mobile phone may include the function for performing an operation input with respect to the rechargeable radio 10, and accordingly it may be possible to easily utilize the smart phone 91 as an operation input device of the rechargeable radio 10. Usually, the smart phone 91 may be connected to the Internet, and accordingly it may be possible to easily and conveniently install the application. The smart phone 91 may be an example of the portable external devices, and the portable external device may be a tablet or a portable music player.

It may be configured that sound data can be transmitted and received between the smart phone 91 and the rechargeable radio 10. For example, it may be configured that the rechargeable radio 10 can access to data such as large-sized music data etc. stored in the smart phone 91, and also, the smart phone 91 can access to large-sized music data etc. stored in the rechargeable radio 10. In the data access of the music data stored in the rechargeable radio 10, there are included both the case where streaming reproduction of the music data is performed and the case where the music data is stored in the data storage part 23 of the control section 20 and then reproduced.

In the control section 20, it may be possible to perform an appropriate control processing even when, for example, a data access relating to the streaming reproduction is being performed. For example, it may be possible to perform an appropriate operation during the streaming reproduction such as adding or changing a control processing or performing the streaming reproduction itself based on either one of a foreground processing and a background processing. The sound data may include not only data relating to sound but also sound files such as data creation time, owners of the data, and other data-related information.

A user of the rechargeable radio 10 may be informed by the smart phone 91 that a remaining battery capacity of the electric power tool battery 80 attached as the power source has been decreased. Because of this, it may be possible for the user of the rechargeable radio 10 to easily recognize when to replace the electric power tool battery 80 of the rechargeable radio 10. Furthermore, it may also be possible for the user of the rechargeable radio 10 to recognize earlier and more easily when to replace the electric power tool battery 80, since the user can always carry the smart phone 91.

The rechargeable radio 10 may output information about a disconnection of the radio communication of the radio communication section 70 by use of the control section 20. For example, when a distance between the rechargeable radio 10 and the smart phone 91 becomes not less than a predetermined distance and the radio communication between the rechargeable radio 10 and the smart phone 91 is disconnected, either one or both of the rechargeable radio 10 and the smart phone 91 may output the information, i.e., inform the user of the fact about the disconnection. Such information output may include a sound output, a display output, and a vibration output. Because of this, even when, for example, the rechargeable radio 10 is likely to be stolen, the user of the rechargeable radio 10 may be informed of the fact that the rechargeable radio 10 is being taken away through the information output of the rechargeable radio 10 or the smart phone 91.

[Third Usage Example]

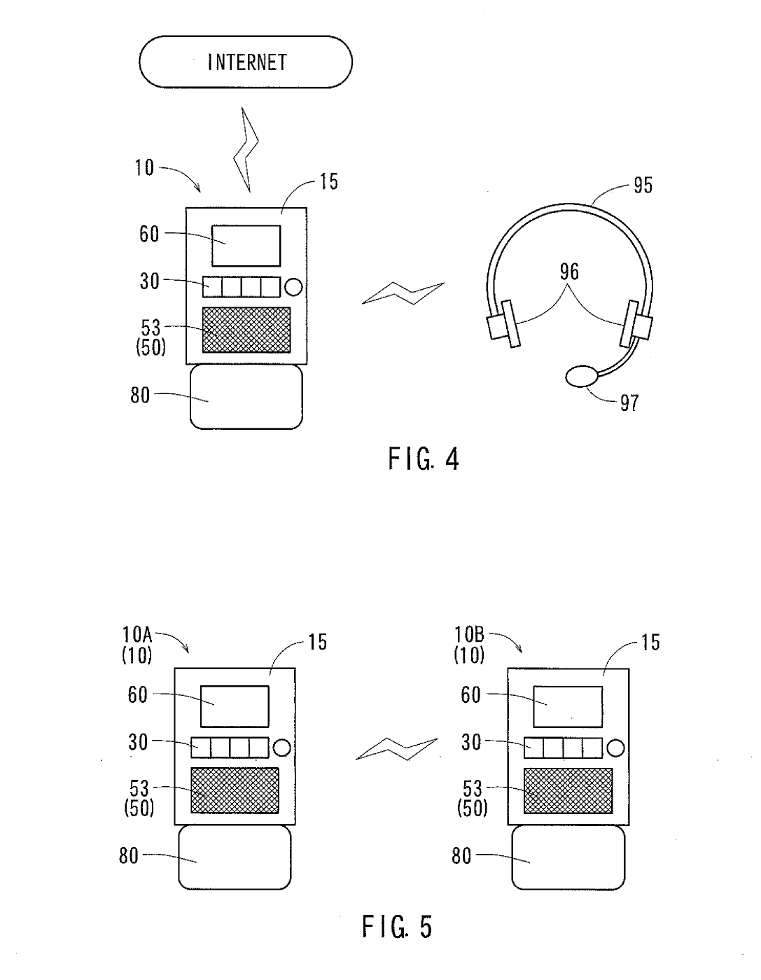

Next, the third usage example of the rechargeable radio 10, constructed as described above, will be described with reference to FIG. 4. FIG. 4 is a schematic diagram schematically illustrating the third usage example of the rechargeable radio 10. In the third usage example shown in FIG. 4, the rechargeable radio 10 may perform a radio communication with a headphone microphone 95. The headphone microphone 95 may correspond to a hands-free device as the external device according to the present embodiment. The headphone microphone 95 may include a radio communication function such as “Bluetooth (registered trademark)” or “ZigBee (registered trademark)” allowing an access to the radio communication section 70 mentioned above.

The headphone microphone 95 may be a widely used headphone microphone, and a microphone 97 may be attached to a normal headphone 96. The headphone microphone 95 may access to the radio communication section 70 of the rechargeable radio 10 by utilizing the above-mentioned radio communication function, making it possible to input and output sound data to and from the rechargeable radio 10. Because of this, the user of the rechargeable radio 10 can listen to a radio broadcasting, etc. transmitted from the rechargeable radio 10. That is, it may be possible for the user of the rechargeable radio 10 to conduct a work while enjoying radio broadcasting, etc.

In a case where the radio communication section 70 of the rechargeable radio 10 is provided with a radio LAN, it may be possible to perform a conversation in a hands-free manner via the Internet. In the above-described rechargeable radio 10, even in a case where a mobile phone, a smart phone or the like is connected thereto in a wireless or wired fashion, it may be possible for the user of the rechargeable radio 10 to perform a conversation in a hands-free manner. That is, in the rechargeable radio 10, by use of the headphone microphone 95 (hands-free device), it may possible for the user to input and output sound data to and from the rechargeable radio 10 via the radio communication section 70, with his hands being free. This may be convenient for the user of the rechargeable radio when using the rechargeable radio 10. The hands-free device thus constructed may not be restricted to the headphone microphone 95 mentioned above, and may also be any other external device allowing an input or output of sound data to or from the rechargeable radio 10.

[Fourth Usage Example]

Next, the fourth usage example of the rechargeable radio 10, constructed as described above, will be described with reference to FIG. 5. FIG. 5 is a schematic diagram schematically illustrating the fourth usage example of the rechargeable radio 10. In the fourth usage example shown in FIG. 5, a radio communication may be possible between rechargeable radios 10A and 10B. That is, an external device for the rechargeable radio 10A (10) may be formed by the other rechargeable radio 10B (10). In this case, sound data stored in the data storage part 23 of the rechargeable radio 10A can be used by the other rechargeable radio 10B via the radio communication section 70.

The way in which the sound data is utilized may include both the case where streaming reproduction of the music data is performed and the case where the sound data is stored in the data storage part 23 of the control section 20 and then reproduced. That is, a mutual radio communication may be possible between the radio communication section 70 of the rechargeable radio 10A and that of the other rechargeable radio 10B. Sound data input to and stored in one rechargeable radio 10A may be transferred to the other rechargeable radio 10B via the radio communication section 70 such that the other rechargeable radio 10B may output the sound data. That is, in this rechargeable radio 10, the sound data to be enjoyed by using the rechargeable radio 10A can also be utilized by the other rechargeable radio 10B. Because of this, a radio broadcasting, music, etc. that can be enjoyed by using the rechargeable radio 10A can also be enjoyed by using the other rechargeable radio 10B, which may be very convenient for the user of the rechargeable radio 10.

In the rechargeable radio 10, a sound input from the rechargeable radio 10A via the microphone part 40 can be output through the speaker part 53 of the other rechargeable radio 10B via the radio communication section 70. Because of this construction, the rechargeable radios 10A and 10B can be used like transceivers. Furthermore, in the rechargeable radio 10, it may be possible to inform the user of a disconnection of the radio communication of the radio communication section 70 by the control processing part 21. That is, when a distance between the rechargeable radios 10A and 10B becomes not less than a predetermined distance, the user of the rechargeable radio 10 may be informed of the fact of the disconnection. Because of this, when, for example, the rechargeable radio 10 is likely to be stolen, it may be possible for the user of the rechargeable radio 10 to recognize either one of the rechargeable radios 10A and 10B is being taken away through the information from both the rechargeable radios 10A and 10B.

[FifthUsage Example]

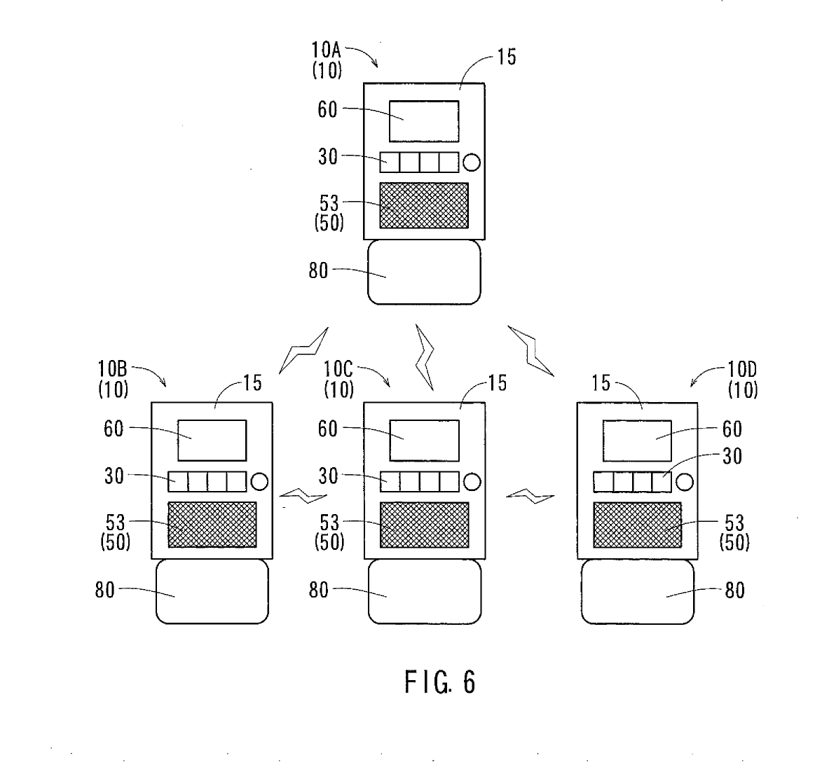

Next, the fifth usage example, which is a modified example of the fourth usage example of the rechargeable radio 10 constructed as described above, will be described with reference to FIG. 6. FIG. 6 is a schematic diagram schematically illustrating the fifth usage example of the rechargeable radio 10. In the fifth usage example shown in FIG. 6, a radio communication may be possible between the rechargeable radio 10A and other rechargeable radios 10B, 10C, and 10D. That is, the external devices for the rechargeable radio 10A (10) may be formed by the other separate rechargeable radios 10B (10), 10C (10), and 10D (10). In this case, the sound data stored in the data storage part 23 of the rechargeable radio 10A can be used by the other rechargeable radios 10B, 10C, and 10D via the radio communication section 70. That is, a mutual radio communication may be possible between the radio communication section 70 of the rechargeable radio 10A and those of the other rechargeable radios 10B, 10C, and 10D.

The sound data input to and stored in the rechargeable radio 10A may be transferred to the other rechargeable radios 10B, 10C, and 10D via the radio communication section 70 such that the other rechargeable radios 10B, 10C, and 10D may output the sound data. That is, in this rechargeable radio 10, the sound data that can be enjoyed by using one rechargeable radio 10A can also be output from the other rechargeable radios 10B, 10C, and 10D. Because of this, a radio broadcasting, music, etc. that can be enjoyed by using the rechargeable radio 10A can also be enjoyed by using the other rechargeable radios 10B, 10C, and 10D, which may be very convenient for the user of the rechargeable radio 10.

Regarding the other rechargeable radios 10B, 10C, and 10D, a radio communication can also be possible between them. Because of this, the sound data to be output by using one rechargeable radio 10A can be transferred to another rechargeable radio 10C so as to be capable of being output, utilizing the rechargeable radio 10B as an access point. The other rechargeable radio(s) with respect to the rechargeable radio may be one rechargeable radio or a plurality of rechargeable radios.

The sound output from the rechargeable radio 10A can be simultaneously output from the plurality of rechargeable radios 10B, 10C, and 10D, so that it may be possible to extend a range where the output sound is audible. In the rechargeable radio 10, a sound input by the microphone part 40 of the rechargeable radio 10A can be output through the speaker part 53 of the other rechargeable radios 10B, 10C, and 10D. Because of this, when the volume of the other rechargeable radios 10B, 10C, and 10D are raised, the other rechargeable radios 10B, 10C, and 10D can be utilized as a loudspeaker for the rechargeable radio 10A.

In the rechargeable radio 10, it may be possible to generate, by the control processing part 21, a sound whose frequency includes a reverse phase with respect to the sound input from the microphone part 40, and can output the generated sound through the speaker part 53, so that it may be possible to decrease a volume of the external sound by using the generated sound output from the speaker part 53 of the rechargeable radio 10. Because of this, it may be possible to decrease a volume of the noisy external sound on a work site. Accordingly, it may be possible to make conversation voices on the work site easier to understand and also to reduce the noise level in the neighborhood, thereby improving a work environment.

The function by which the volume of the external sound is thus decreased can be used like a noise canceller that can cancel noises. When this function is thus used, it may be possible to make a sound output from the rechargeable radio 10 (radio broadcasting, music, conversation, etc.) easier to understand. Furthermore, it may also be possible to use only one rechargeable radio 10A as a loudspeaker by using the microphone part 40 and the speaker part 53 thereof.

The rechargeable radio according to the present embodiment is not restricted to the above-described embodiments but allows appropriate modification as described below. In the above-described embodiment, there is provided the radio communication section 70 for improving flexibility in terms of linkage with the external devices. Any appropriate other constructions for improving flexibility in terms of linkage with the external devices may be adopted. The external devices used in the first usage example through fourth usage example may be only examples, and it may be possible to use any other appropriate external devices.

The above first usage example through the fourth usage example may be combined with each other as needed. For example, when the rechargeable radio is used as a loudspeaker as described in the fourth usage example, a sound may be from the smart phone 91, a tablet, or a portable music player as described in the second usage example.

1. A rechargeable radio to which an electric power tool battery is attached as a power source, comprising,
a radio communication section configured to perform a radio communication with an external device separate from the rechargeable radio.

2. The rechargeable radio according to claim 1, wherein,
an input and output of a sound relating to the external device is performed via the rechargeable radio by performing a radio communication with the external device via the radio communication section.

3. The rechargeable radio according to claim 1, wherein,
the external device includes an operation input device for performing an operation input relating to the rechargeable radio via the radio communication section.

4. The rechargeable radio according to claim 3, wherein,
a function for performing the operation input is installed in the external device having other functions by installing an application provided from outside.

5. The rechargeable radio according to claim 1, wherein,
the radio communication section is configured to transfer a sound data to the external device.

6. The rechargeable radio according to claim 5, wherein,
the rechargeable radio includes a data storage part that stores the sound data;
the external device includes an other rechargeable radio separate from the rechargeable radio; and
the sound data stored in the data storage part in the rechargeable radio can be utilized in the other rechargeable radio via the radio communication section.

7. The rechargeable radio according to claim 1, wherein,
a radio communication is performed between the radio communication section of the rechargeable radio and that of the other rechargeable radio.

8. The rechargeable radio according to claim 1, wherein,
a sound input through a microphone part of the rechargeable radio is output from a speaker part of the other rechargeable radio via the radio communication section.

9. The rechargeable radio according to claim 1, wherein,
the rechargeable radio includes a control processing part configured to control and process an output to the speaker part in correspondence with an input from the microphone part; and
the control processing part generates a sound whose frequency includes a reverse phase with respect to the sound input from the microphone part, and outputs the generated sound to the speaker part.

10. The rechargeable radio according to claim 1, wherein,
the rechargeable radio includes a battery remaining capacity detection part configured to detect a remaining capacity of the electric power tool battery attached as the power source; and
when the remaining capacity detected by the battery remaining capacity detection part becomes less than a predetermined value, a signal relating to the remaining capacity is transmitted to the external device via the radio communication section.

11. The rechargeable radio according to claim 1, wherein,
when the radio communication with the external device via the radio communication section is disconnected, information about the disconnection is informed.
